(19) United States
(12) Patent Application Publication
(10) Pub. No.: US 2007/0248094 A1
(43) Pub. Date: Oct. 25, 2007

(54) SYSTEM AND METHOD FOR SETTING NETWORK PARAMETERS

(75) Inventors: CHIH-LUNG CHEN, Tu-Cheng (TW); CHIH-WEI TUNG, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/560,858

(22) Filed: Nov. 17, 2006

(30) Foreign Application Priority Data
Apr. 21, 2006 (TW) 095114368

(51) Int. Cl. H04L 12/56

(52) U.S. Cl. 370/392; 370/254

(57) ABSTRACT

A system for setting network parameters is provided. The system is arranged in a network device connected to a client, and includes a detecting module, a packet determining module, a transmission module, and a parameter setting module. The detecting module detects packets from the client at a port. The packet determining module determines types of the packets, the types of the packet including a SET packet. The transmission module transmits corresponding response packets to the client according to the types of the packet. The parameter setting module sets network parameters of the network device and the client according to the SET packet. A method for setting network parameters is also provided.

### BACKGROUND OF THE INVENTION

1. Field of the Invention

The invention generally relates to a system and method, and particularly to a system and method for setting a network parameter.

2. Description of Related Art

With wide popularity of the Internet, more and more users access the Internet via network devices such as switches, modems, access points, and so on.

Typically, after a user brings a new network device home, he or she needs to read a user guide thereof to set network parameters of the network device, which is time-consuming and bothersome. Moreover, every time the network device is connected to a new client, the user has to reset the network parameters again, which is quite inconvenient.

Therefore, a heretofore unaddressed need exists in the industry to overcome the aforementioned deficiencies and inadequacies.

### SUMMARY OF THE INVENTION

A system for setting network parameters is provided. The system is arranged in a network device connected to a client, and includes a detecting module, a packet determining module, a transmission module, and a parameter setting module. The detecting module detects packets from the client at a port. The packet determining module determines types of the packets, the types of the packets including a SET packet. The transmission module transmits corresponding response packets to the client according to the type of the packet. The parameter setting module sets network parameters of the network device and the client according to the SET packet. A method for setting network parameters is also provided.

A method for setting network parameters is provided, the method is applicable to a network device connected to a client, and includes: detecting a session request packet from the client at a port; detecting a GET packet from the client after detecting the session request packet, and transmitting network parameters of the network device to the client after detecting the GET packet; detecting a SET packet from the client, and setting network parameters of the network device and the client after detecting the SET packet.

Other advantages and novel features will become more apparent from the following detailed description when taken in conjunction with the accompanying drawings, in which:

### BRIEF DESCRIPTION OF THE DRAWINGS

FIG. 1 is a schematic diagram illustrating an application environment of a system for setting a network parameter of an exemplary embodiment of the invention;

FIG. 2 is a block diagram of the system of an exemplary embodiment of the invention;

FIG. 3 is a flowchart of the method for setting a network parameter of another exemplary embodiment of the invention;

FIG. 4 is a detailed flowchart of a step S304 in FIG. 3;

FIG. 5 is a detailed flowchart of a step S306 in FIG. 3;

FIG. 6 is a detailed flowchart of a step S308 in FIG. 3;

FIG. 7 is a detailed flowchart of a step S310 in FIG. 3; and

FIG. 8 is a detailed flowchart of a step S312 in FIG. 3.

### DETAILED DESCRIPTION OF THE INVENTION

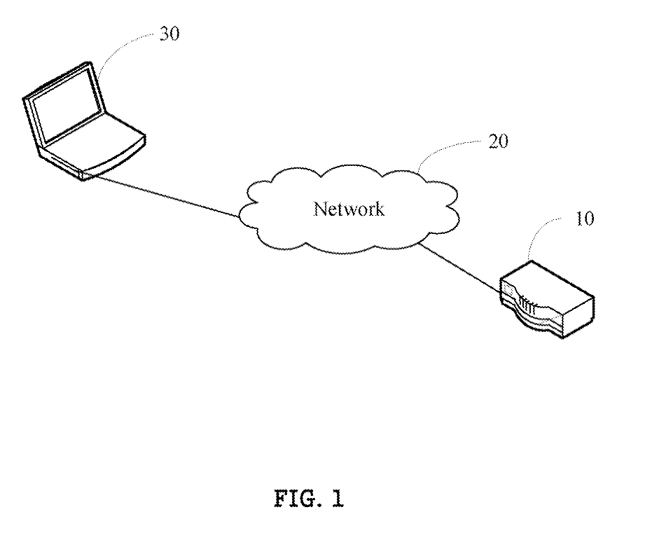

FIG. 1 is a schematic diagram illustrating an application environment of a system for setting network parameters of an exemplary embodiment of the invention.

The system for setting network parameters 100 is arranged in a network device 10. A client 30 is connected to the network device 10 via a network 20. In this embodiment, the network device may be an access point, a wireless modem, and so on. The network 20 may be the Internet, an Intranet, and so on. The client 30 may be a personal computer (PC), a personal digital assistant (PDA), a set top box, and so on.

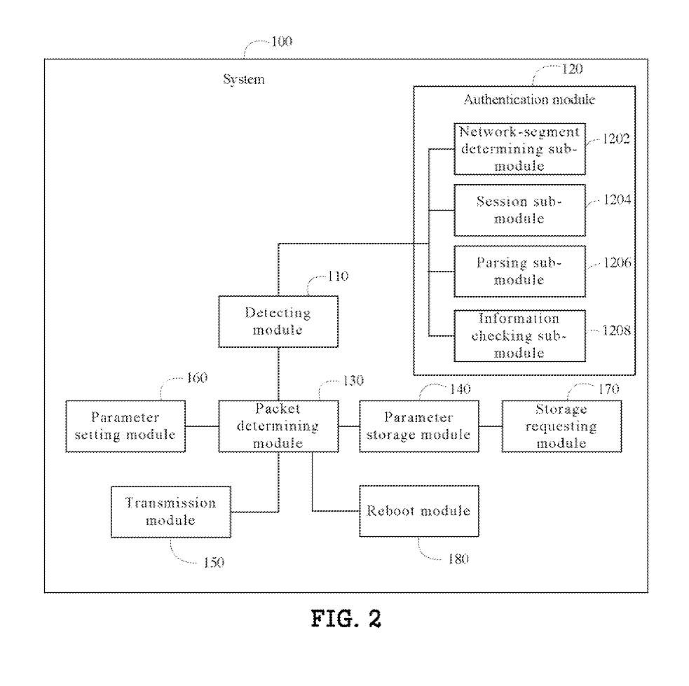

FIG. 2 is a block diagram of the system 100 of an exemplary embodiment of the invention.

The system 100 includes a detecting module 110, an authentication module 120, a packet determining module 130, a parameter storage module 140, a transmission module 150, a parameter setting module 160, a storage requesting module 170, and a reboot module 180.

The detecting module 110 detects a session request packet from the client 30 via a port. In this embodiment, the detecting module 110 detects the session request packet via a port 55600.

The authentication module 120 authenticates the client 30. In this embodiment, the authentication module 120 includes a network-segment determining sub-module 1202, a session sub-module 1204, a parsing sub-module 1206, and an information checking sub-module 1208.

The network-segment determining sub-module 1202 determines whether the client 30 is in a valid network segment. The valid network segment refers to a network segment that the client 30 is allowed to visit. In this embodiment, the network-segment determining sub-module 1202 determines whether a client 30 is in the valid network segment by checking an Internet protocol (IP) address and a subnet mask of the packet.

The session sub-module 1204 establishes a session with a client 30 in a valid network segment. In this embodiment, a session refers to a communication between a port of the client 30 and that of the network device 10.

The parsing sub-module 1206 parses a packet from the client 30 in a valid network segment, to determine whether the packet includes user information. In this embodiment, the user information includes a username and a password. In detail, the parsing sub-module 1206 parses a payload field in the packet, to determine whether the payload field includes the username and the password.

The information checking sub-module 1208 checks the packet from the client 30 in a valid network segment, to determine whether the packet includes correct user information. In detail, the information checking sub-module 1208 determines whether the username and the password in the packet are correct.

The packet determining module 130 determines types of packets from the client 30. In this embodiment, the types of packets include a GET packet, a SET packet, a SAVE packet, and a REBOOT packet. The packet determining module 130 determines the types of packets by checking a code field of each of the packets.

If the packet determining module 130 determines the code field of a packet is set to 0x01, that indicates the packet is a GET packet. A typical format of the GET packet is as follows:

| | | | | |
|---|---|---|---|---|
| Code | IP | UPnP | WEP | NAPT |

An IP field, a UPnP field, a WEP field and a NAPT field respectively indicate an Internet protocol (IP) address, a universal plug and play protocol (UPnP) function, a wireless equivalent privacy (WEP) function, and a network address and protocol translation (NAPT) function.

If the packet determining module 130 determines the code field of a packet is 0x02, that indicates the packet is a SET packet. The SET packet indicates network parameters of the client 30. A typical format of the SET packet is as follows:

| | | | | |
|---|---|---|---|---|
| Code | IP = 192.168.0.242 | UpnP = 1 | WEP = 0 | NAPT = 0 |

### The IP field indicates the IP address of the client 30 is 192.168.0.242, the UPnP field indicates the UPnP function thereof is enabled, and the WEP field and the NAPT field indicate the WEP and the NAPT functions thereof are not enabled.

If the packet determining module 130 determines the code field of a packet is 0x07, that indicates the packet is a SAVE packet. The SAVE packet is a request for saving network parameters of the network device 10 and the client 30. A typical format of the SAVE packet is as follows:

| | |
|---|---|
| Code | SAVE |

If the packet determining module 130 determines the code field of a packet is 0x06, that indicates the packet is a REBOOT packet. The REBOOT packet is a request for rebooting the network device 10 and the client 30. A typical format of the REBOOT packet is as follows:

| | |
|---|---|
| Code | REBOOT |

The parameter storage module 140 stores the network parameters of the network device 10 and the client 30. For example, the network parameters of the network device 10 are preset to UPnP=0, IP=192.168.0.10, NAPT=1, WEP=1, and the network parameters of the client 30 are preset to UPnP=1, IP=192.168.0.242, NAPT=0, WEP=0.

The transmission module 150 transmits corresponding response packets to the client 30 according to the types of the packets from the client 30. In this embodiment, if a packet from the client 30 is the GET packet, a corresponding response packet is a GET response packet. The GET response packet indicates the network parameters of the network device 10. A typical format of the GET response packet is as follows:

| | | | | |
|---|---|---|---|---|
| Code | IP = 192.168.0.10 | UpnP = 0 | WEP = 1 | NAPT = 1 |

The GET response packet indicates an IP address of the network device 10 is 102.168.0.10, the UPnP function thereof is not enabled, and the WEP and the NAPT functions thereof are enabled.

If the packet from the client 30 is the SET packet, a corresponding response packet is a SET response packet. A typical format of the SET response packet is as follows:

| | |
|---|---|
| Code | OK |

The SET response packet indicates the network parameters of the network device 10 have been successfully set.

If the packet from the client 30 is the SAVE packet, a corresponding response packet is a SAVE response packet. A typical format of the SAVE response packet is as follows:

| | |
|---|---|
| Code | SAVE OK |

The SAVE response packet indicates the network parameters of the network device 10 and the client 30 have been successfully saved.

If the packet from the client 30 is the REBOOT packet, a corresponding response packet is a REBOOT response packet. A typical format of the REBOOT response packet is as follows:

| | |
|---|---|
| Code | REBOOT OK |

The REBOOT response packet indicates the network device 10 and the client 30 have been successfully rebooted.

The parameter setting module 160 sets the network parameters of the network device 10 and the client 30. In detail, the parameter setting module 160 sets a UPnP value of the network device 10 according to that of the client 30, and sets an IP address, a NAPT value, and a WEP value of the client 30 according to those of the network device 10. In this embodiment, the parameter setting module 160 sets the UPnP value of the network device 10 to 1, and sets the IP address, the WEP value, and the NAPT value of the client 30, to 192.168.0.10, 1, and 1, respectively.

The storage requesting module 170 requests the parameter storage module 140 to store the network parameters of the network device 10 and the client 30 according to the SAVE packet.

The reboot module 180 reboots the network device 10 and the client 30 according to the REBOOT packet.

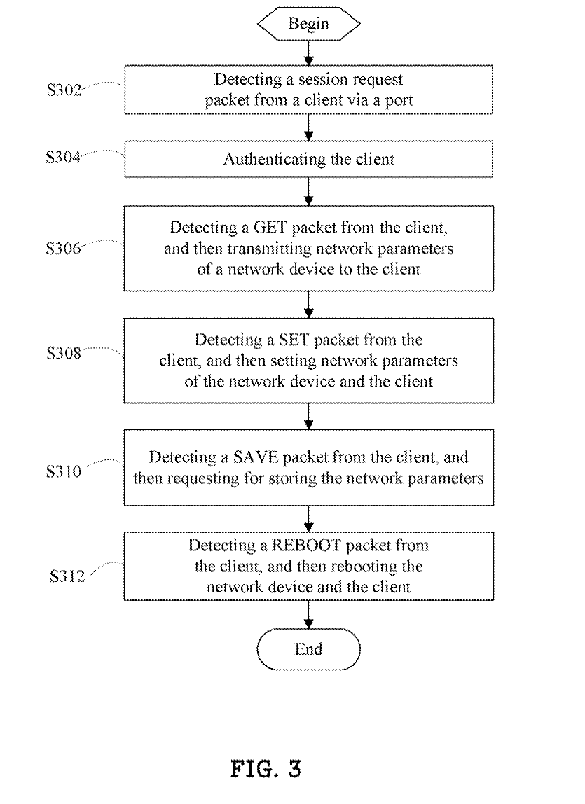

FIG. 3 is a flowchart of the method for setting network parameters of another exemplary embodiment of the invention.

In step S302, the detecting module 110 detects the session request packet from the client 30 via the port.

In step S304, the authentication module 120 authenticates the client 30, to prevent unauthorized users from logging onto the network device 10 and setting network parameters thereof.

In step S306, the detecting module 110 detects a GET packet from the client 30, and then the transmission module 150 transmits the network parameters of the network device 10 to the client 30.

In step S308, the detecting module 110 detects a SET packet from the client 30, and then the parameter setting module 160 sets network parameters of the network device 10 and the client 30.

In step S310, the detecting module 110 detects a SAVE packet from the client 30, and then the storage requesting module 170 requests the parameter setting module 140 to store the network parameters set by the parameter setting module 160.

In step S312, the detecting module 110 detects a REBOOT packet from the client 30, and then the reboot module 180 reboots the network device 10 and the client 30.

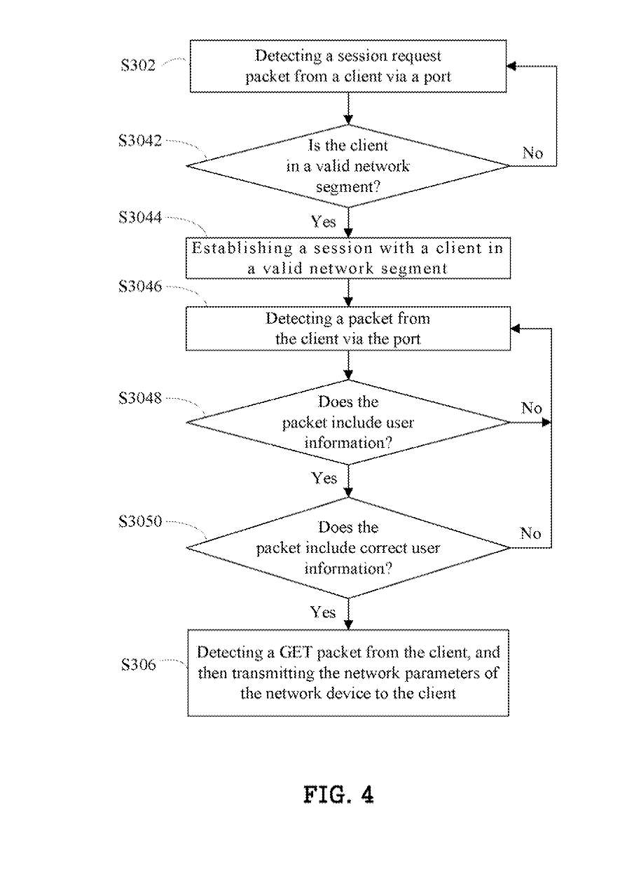

FIG. 4 is a flowchart showing detailed steps of the step S304 in FIG. 3.

In step S3042, the network-segment determining sub-module 1202 checks whether the client 30 is in a valid network segment. If the client 30 is in a valid network segment, the process proceeds to step S3044. If the client 30 is not in a valid network segment, the process returns to step S302.

In step S3044, the session sub-module 1204 establishes a session with the client 30 in a valid network segment.

In step S3046, the detecting module 110 detects a packet from the client 30 via the port.

In step S3048, the parsing sub-module 1206 parses the packet, to determine whether the packet includes user information. If the packet includes the user information, the process proceeds to step S3050. If the packet does not include the user information, the process returns to step S3046.

The information checking sub-module 1208 checks whether the packet includes correct user information. If the packet includes correct user information, the process proceeds to step S314. If the packet does not include correct user information, the process returns to step S3046. Note that the steps S302 and S306 in FIG. 4 are the same as those in FIG. 3, and thus, descriptions thereof are omitted.

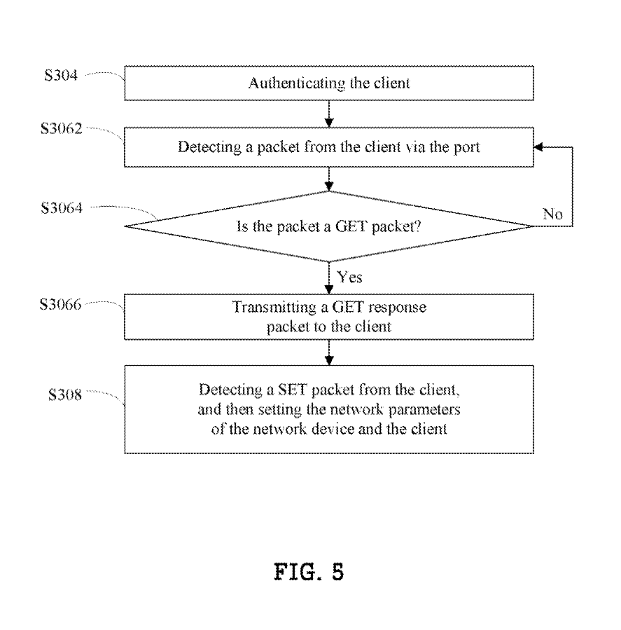

FIG. 5 is a flowchart showing detailed steps of the step S306 in FIG. 3.

In step S3062, the detecting module 110 detects a packet from the client 30 via the port.

In step S3064, the packet determining module 130 determines whether the packet is the GET packet. If the packet is the GET packet, the process proceeds to step S3066. If the packet is not the GET packet, the process returns to step S3062.

In step S3066, the transmission module 150 transmits the GET response packet to the client 30. Note that the steps S304 and S308 in FIG. 5 are the same as those in FIG. 3, and thus, descriptions thereof are omitted.

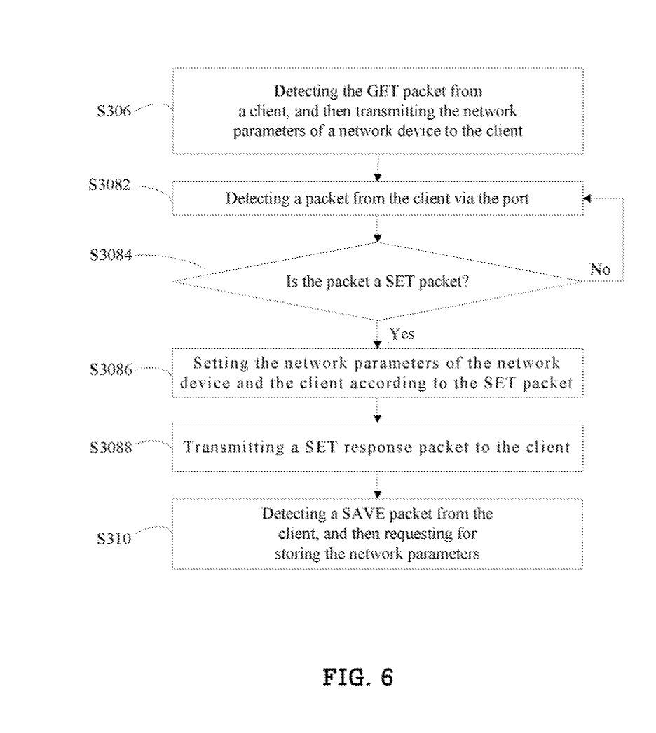

FIG. 6 is a flowchart showing detailed steps of the step S308 in FIG. 3.

In step S3082, the detecting module 110 detects a packet from the client 30 via the port.

In step S3084, the packet determining module 130 determines whether the packet is the SET packet. If the packet is the SET packet, the process proceeds to step S3086. If the packet is not the SET packet, the process returns to step S3082.

In step S3086, the parameter setting module 160 sets the network parameters of the network device 10 and the client 30 according to the SET packet.

In step S3088, the transmission module 150 transmits the SET response packet to the client 30. Note that the steps S306 and S310 in FIG. 5 are the same as those in FIG. 3, and thus, descriptions thereof are omitted.

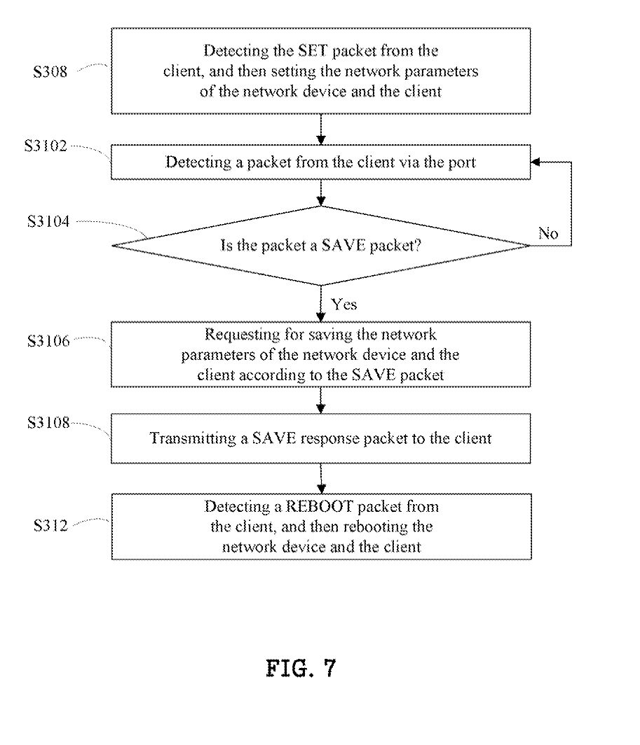

FIG. 7 is a flowchart showing detailed steps of the step S310 in FIG. 3.

In step S3102, the detecting module 110 detects a packet from the client 30 via the port.

In step S3104, the packet determining module 130 determines whether the packet is the SAVE packet. If the packet is the SAVE packet, the process proceeds to step S3106. If the packet is not the SAVE packet, the process returns to step S3102.

In step S3106, the storage requesting module 170 requests the parameter storage module 140 save the network parameters of the network device 10 and the client 30 according to the SAVE packet.

In step S3108, the transmission module 150 transmits the SAVE response packet to the client 30. Note that the steps S308 and S312 in FIG. 6 are the same as those in FIG. 3, and thus, descriptions thereof are omitted.

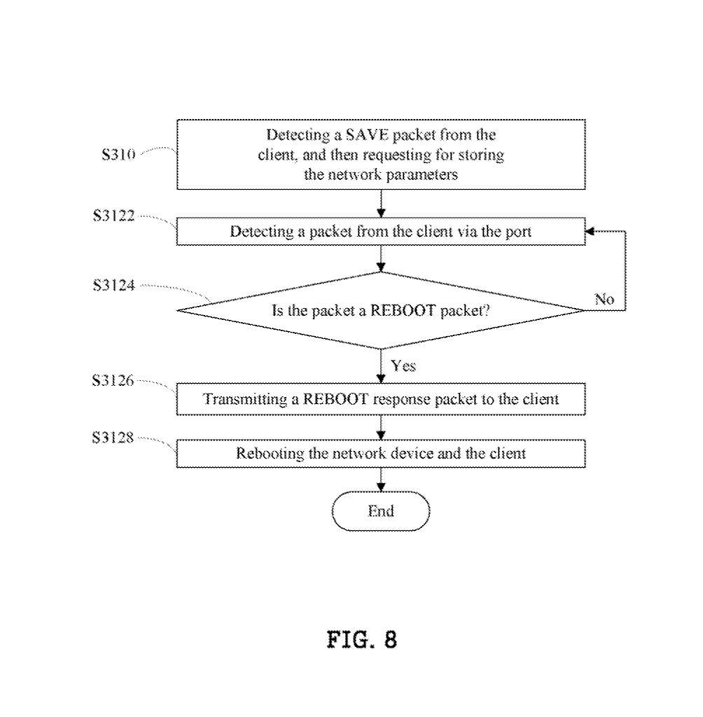

FIG. 8 is a flowchart showing detailed steps of the step S312 in FIG. 3.

In step S3122, the detecting module 110 detects a packet from the client 30 via the port.

In step S3124, the packet determining module 130 determines whether the packet is the REBOOT packet. If the packet is the REBOOT packet, the process proceeds to step S3126. If the packet is not the REBOOT packet, the process returns to step S3122.

In step S3126, the transmission module 150 transmits the REBOOT response packet to the client 30.

In step S3128, the reboot module 180 reboots the network device 10 and the client 30 according to the REBOOT packet.

What is claimed is:

1. A system for setting network parameters, the system arranged in a network device connected to a client, and comprising:
a detecting module for detecting packets from the client via a port;
a packet determining module for determining types of the packets, the types of the packets comprising a SET packet;
a transmission module for transmitting corresponding response packets to the client according to the types of the packets; and
a parameter setting module for setting network parameters of the network device and the client according to the SET packet.

2. The system as claimed in claim 2, further comprising a parameter storage module for storing the network parameters of the network device and the client.

3. The system as claimed in claim 1, wherein the types of packets further comprise a GET packet.

4. The system as claimed in claim 1, wherein the types of packets further comprise a SAVE packet.

5. The system as claimed in claim 4, further comprising a storage requesting module for requesting the parameter storage module to store the network parameters of the network device and the client according to the SAVE packet.

6. The system as claimed in claim 1, wherein the types of packets further comprise a REBOOT packet.

7. The system as claimed in claim 6, further comprising a reboot module for rebooting the network and the client according to the REBOOT packet.

8. The system as claimed in claim 7, further comprising an authentication module for authenticating the client.

9. The system as claimed in claim 8, wherein the authentication module further comprises:
a network-segment determining sub-module for determining whether the client is in a valid network segment;
a session sub-module for establishing a session with the client in a valid network segment;
a parsing sub-module for parsing a packet from the client in a valid network segment, to determine whether the packet comprises user information; and
an information checking sub-module for checking whether the packet comprises correct user information.

10. The system as claimed in claim 1, wherein the response packets comprise a GET response packet, a SET response packet, a SAVE response packet and a REBOOT response packet.

11. A method for setting a network parameter, the method applicable to a network device connected to a client, and comprising:
detecting a session request packet from the client via a port;
detecting a GET packet from the client after detecting the session request packet, and transmitting network parameters of the network device to the client after detecting the GET packet; and
detecting a SET packet from the client, and setting network parameters of the network device and the client after detecting the SET packet.

12. The method as claimed in claim 11, wherein the step of detecting a GET packet from the client after detecting the session request packet, and transmitting network parameters of the network device to the client after detecting the GET packet comprises:
detecting a packet from the client;
determining whether the packet is the GET packet; and
transmitting a GET response packet to the client if the packet is the GET packet.

13. The method as claimed in claim 11, wherein the step of detecting a SET packet from the client, and setting network parameters of the network device and the client after detecting the SET packet comprises:
detecting a packet from the client;
determining whether the packet is the SET packet;
setting the network parameters of the network device and the client if the packet is the SET packet; and
transmitting a SET response packet to the client.

14. The method as claimed in claim 11, further comprising authenticating the client after detecting the session request packet.

15. The method as claimed in claim 14, wherein the step of authenticating the client after detecting the session request packet comprises:
determining whether the client is in a valid network segment;
establishing a session with the client if the client is in a valid network segment;
detecting a packet from the client via the port;
parsing the packet to determine whether the packet comprises user information; and
checking whether the packet includes correct user information if the packet comprises user information.

16. The method as claimed in claim 11, further comprising detecting a SAVE packet from the client, and storing network parameters of the network device and the client after detecting the SAVE packet.

17. The method as claimed in claim 16, wherein the step of detecting a SAVE packet from the client, and storing network parameters of the network device and the client after detecting the SAVE packet comprises:
detecting a packet from the client;
determining whether the packet is the SAVE packet;
storing the network parameters of the network device and the client if the packet is the SAVE packet; and
transmitting a SAVE response packet to the client.

18. The method as claimed in claim 11, further comprising detecting a REBOOT packet from the client, and rebooting the network device and the client after detecting the REBOOT packet.

19. The method as claimed in claim 18, wherein the step of detecting a REBOOT packet from the client, and rebooting the network device and the client after detecting the REBOOT packet comprises:
detecting a packet from the client;
determining whether the packet is the REBOOT packet;
transmitting a REBOOT response packet to the client if the packet is the REBOOT packet; and
rebooting the network device and the client.

20. A method for setting network parameters for network devices and clients communicable therewith, comprising steps of:
communicating a client with a network device;
detecting a session request packet from said client;
authenticating said client;
transmitting network parameters from said network device to said client after said session request packet from said client is identified as to request said network parameters; and
setting said network parameters in said network device and said client after said session request packet from said client is identified as to set said network parameters.
